(19) United States
(12) Patent Application Publication
(10) Pub. No.: US 2025/0138468 A1
(43) Pub. Date: May 1, 2025

(54) ELECTROSTATIC COLLECTING DEVICE, IMAGE FORMING DEVICE, AND CLEANING DEVICE

(71) Applicant: CANON KABUSHIKI KAISHA, Tokyo (JP)

(72) Inventors: TOMOAKI NAKAI, Shizuoka (JP); YUKI NISHIZAWA, Kanagawa (JP); YU IZAKI, Shizuoka (JP)

(21) Appl. No.: 18/924,854

(22) Filed: Oct. 23, 2024

(30) Foreign Application Priority Data
Oct. 31, 2023 (JP) 2023-186869

(51) Int. Cl. G03G 21/00; G03G 15/16; G03G 21/12

(52) U.S. Cl. CPC G03G 21/0047; G03G 15/161; G03G 15/168; G03G 21/0011; G03G 21/0035; G03G 21/12

(57) ABSTRACT

An electrostatic collecting device including a collecting unit facing a surface of an object to be cleaned, electrostatically collecting objects to be collected existing on the surface of the object to be cleaned, and having a rotating body and a brush provided on a surface of the rotating body; a charging unit having an insulating member rubbing against the collecting unit and charging the collecting unit by the insulating member; and a charge removing unit contacting a surface of the charging unit, electrically grounded to remove charge from the surface of the charging unit, and having a conductive brush, charge removing needle, or conductive sheet contacting the charging unit.

### BACKGROUND

### Technical Field

The present disclosure relates to an electrostatic collecting device that electrostatically collects objects to be collected on the surface of an object to be cleaned, and also to an image forming device and a cleaning device equipped with the electrostatic collecting device.

### Description of the Related Art

Techniques are presently being developed for collecting and removing foreign objects and unnecessary substances by using electrostatic attraction in various manufacturing equipment and industrial products. For example, Japanese Patent No. 4886097 discloses a technique for collecting and removing foreign objects on the surface of objects with relatively high surface smoothness, such as glass substrates, printed circuit boards (PCB, PCBA, etc.), films, sheets, and plastic plates, by electrostatic attraction.

Furthermore, Japanese Patent Application Publication No. 2017-156450 discloses a technique for collecting and removing paper powder adhered to the surface of paper by electrostatic attraction in an electrophotographic image forming device.

With these techniques, a voltage is applied to a roller or the like to electrostatically attract foreign matter, and the attracted foreign matter is scraped off and collected by a scraping member such as a cleaning blade.

However, the above-mentioned electrostatic collecting device has the following disadvantages. When electrostatic collection is performed with a simple configuration without applying a high voltage, it is necessary to pre-charge a collecting unit such as a brush roller that collects the objects to be collected, and then electrostatically collect the objects. In such devices, in order to improve collection performance, a charging unit is often provided for rubbing against the brush roller, which is the collecting unit. However, even if the number of times of rubbing is increased, the charge quantity on the brush roller, which is the collecting unit, becomes saturated, and as a result, there are cases where the collection performance cannot be improved.

### SUMMARY

Some embodiments of the present disclosure provide an electrostatic collecting device that increases the charge quantity on the collecting unit with a simple configuration and improves the collection performance of the objects to be collected on the surface of the object to be cleaned.

According to an aspect of the present disclosure, an electrostatic collecting device includes a collecting unit facing a surface of an object to be cleaned, electrostatically collecting objects to be collected existing on the surface of the object to be cleaned, and having a rotating body and a brush provided on a surface of the rotating body, a charging unit having an insulating member rubbing against the collecting unit and charging the collecting unit by the insulating member, and a charge removing unit contacting a surface of the charging unit, electrically grounded to remove charge from the surface of the charging unit, and having a conductive brush, charge removing needle, or conductive sheet contacting the charging unit.

Further features of various embodiments of the present disclosure will become apparent from the following description of exemplary embodiments with reference to the attached drawings.

### BRIEF DESCRIPTION OF THE DRAWINGS

FIG. 1 is a cross-sectional view showing the overall configuration of an image forming device of Embodiment 1.

FIG. 2 is a cross-sectional view showing an intermediate transfer belt cleaning device of Embodiment 1.

FIG. 3 is a cross-sectional view showing the overall configuration of an image forming device of Embodiment 2.

FIG. 4 is a cross-sectional view showing an intermediate transfer belt cleaning device of Embodiment 2.

FIGS. 5A to 5D are cross-sectional views showing a brush roller configuration of Embodiment 2.

FIG. 6 is a cross-sectional view showing the overall configuration of an image forming device of Embodiment 3.

FIG. 7 is a cross-sectional view showing a process cartridge of Embodiment 3.

FIG. 8 is a cross-sectional view showing the overall configuration of an image forming device of Embodiment 4.

FIG. 9 is a cross-sectional view showing a process cartridge of Embodiment 4.

FIG. 10 is a cross-sectional view showing the overall configuration of an image forming device of Embodiment 5.

FIG. 11 is a cross-sectional view showing a process cartridge of Embodiment 5.

FIG. 12 is a diagram showing an electrostatic collecting device of Embodiment 6.

FIG. 13 is a cross-sectional view showing the electrostatic collecting device of Embodiment 6.

### DESCRIPTION OF THE EMBODIMENTS

Preferred embodiments of the present disclosure will be described hereinbelow in detail with reference to the drawings. However, unless otherwise specified, the dimensions, materials, shapes, and relative positions of the components described in these embodiments are not intended to limit the scope of the present disclosure to those alone. Furthermore, unless otherwise specified, the materials, shapes, etc. of the members once described in the following description will be the same in the initial and subsequent descriptions.

### Embodiment 1

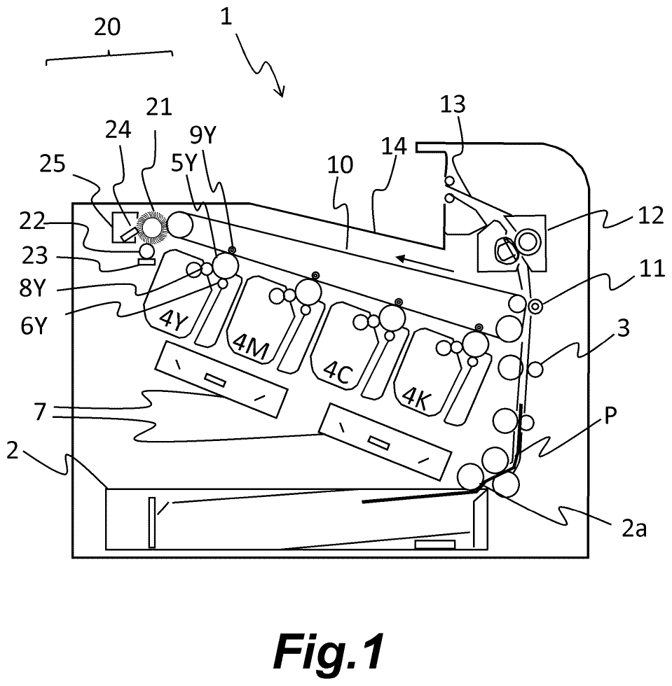

First, a full-color laser beam printer that is an image forming device of Embodiment 1 will be described. FIG. 1 is a cross-sectional view showing the overall configuration of a printer 1 that is a full-color laser beam printer.

First, the basic configuration and operation of the printer 1 will be described. A paper cassette 2 is stored in the lower part of the printer 1 so that the paper cassette can be pulled out. Sheets P are stacked and stored in the paper cassette 2. The sheets P are separated one by one by a separation roller 2a, and fed by a registration roller pair 3 at a conveying speed of 300 mm/sec.

The printer 1 has image forming units 4Y, 4M, 4C, and 4K that are arranged in a horizontal line and correspond to the yellow, magenta, cyan, and black colors. The image forming unit 4Y has a photosensitive drum 5Y, which is an image bearing member, and a charging unit 6Y for uniformly charging the surface of the photosensitive drum 5Y. In addition, a scanner unit 7 that radiates a laser beam based on image information to form an electrostatic latent image on the photosensitive drum 5Y is disposed below the image forming unit 4Y. The scanner unit 7 forms an electrostatic latent image on the photosensitive drum 5Y, and the electrostatic latent image is developed into a toner image by a developing unit 8Y that adheres toner to the electrostatic latent image. The toner image is transferred to an intermediate transfer belt 10, which is an intermediate transfer member, in a primary transfer unit 9Y. The intermediate transfer belt 10 is rotated in the direction of the arrow at 300 mm/sec, which is the same as the paper conveying speed, and the toner images are superimposed through the same process in the image forming units 4M, 4C, and 4K. The superimposed toner images are transferred onto the sheet P, which is a recording medium, in a secondary transfer unit 11, and pass through an image heating device 12 to become an image fixedly attached to the sheet P. The sheet P passes through a discharge conveying unit 13 and is discharged and stacked on a stacking unit 14. The toner that was not transferred to the sheet P and remained on the intermediate transfer belt 10 is collected by a cleaning device 20, which is an embodiment of electrostatic collecting device arranged to contact the intermediate transfer belt 10.

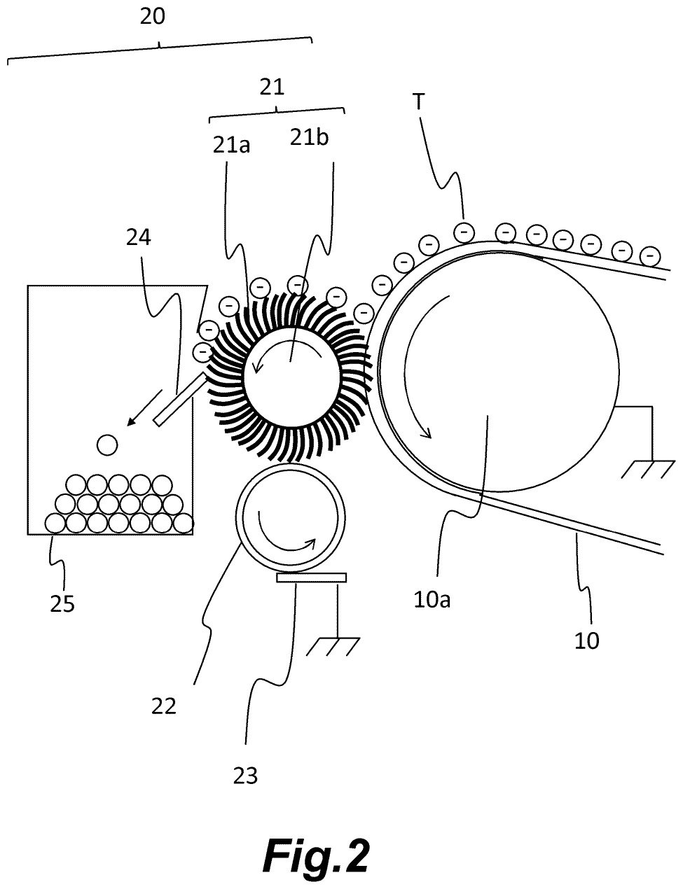

FIG. 2 is a diagram showing the configuration of the cleaning device 20, which is a characteristic feature of Embodiment 1, and how the toner T adhered to the intermediate transfer belt 10 is collected. The intermediate transfer belt 10 is suspended by a suspension roller 10a and rotated in the direction of the arrow. The suspension roller 10a is made of a conductive material such as aluminum and is grounded to GND by a grounding cable (not shown) through a main body frame. The cleaning device 20 includes a brush roller 21 as a collecting unit, a charging roller 22 as a charging unit, a charge removing sheet 23 as a charge removing unit, a blade 24, and a waste toner container 25. Further, the brush roller 21 is provided so as to face the surface of the intermediate transfer belt 10, which is an object to be cleaned, and collects the toner T as objects to be collected on the surface of the intermediate transfer belt 10. The brush roller includes a brush 21a and a core body 21b as a rotating body that holds the brush 21a. The brush 21a is a brush provided on the surface of the core body 21b, which is the rotating body. The brush 21a has insulating bristles made of an insulating material, and at least the charging roller 22 and the brush 21a rub against each other.

Here, the brush roller 21 collects the toner T as the objects to be collected that was not transferred to the sheet P in the secondary transfer unit during image formation and remained adhering to the intermediate transfer belt 10 from the surface of the intermediate transfer belt 10, which is the object to be cleaned. In Embodiment 1, the toner T is charged negatively as the regular charging polarity. Therefore, the surface of the brush roller 21 is charged positively, which is the opposite polarity to the regular charging polarity, and the toner T is collected by the brush roller 21 at the nip between the brush roller 21 and the intermediate transfer belt 10 by electrostatic attraction. Therefore, the material of the brush 21a and the material of the surface layer of the charging roller 22 are selected so that the brush roller 21 is positively charged when the brush roller 21 and the charging roller 22 rub against each other. Also, in order to improve the collection performance of the toner T on the intermediate transfer belt 10, the electrostatic attraction force is strengthened by increasing the charge quantity on the brush roller 21. In general, the polarity and charge quantity of the charge are determined by a triboelectric series, and the charge quantity increases as the two materials are separated in the triboelectric series. In Embodiment 1, the brush 21a is preferably made of wool, nylon, rayon, etc. in order to be charged positively. In Embodiment 1, nylon is used as the material for the brush 21a.

Furthermore, the charging roller 22 has a rotating body and an insulating member that rubs against the brush roller 21, which is the collecting unit, and charges the brush 21a of the brush roller 21 to the opposite polarity (positive) to the charging polarity (negative) of the toner, which is the objects to be collected. Therefore, in Embodiment 1, a material that allows for negative charging is selected for the surface layer of the rotating body of the charging roller 22. For example, polytetrafluoroethylene (PTFE), silicon, polychlorotrifluoroethylene (PCTFE, CTFE), polyvinylidene fluoride (PVDF), polyvinyl fluoride (PVF), perfluoroalkoxyfluororesin (hereinafter PFA), tetrafluoroethylene-hexafluoropolypropylene copolymer (FEP), ethylene-tetrafluoroethylene copolymer (ETFE), ethylene-chlorotrifluoroethylene copolymer (ECTFE), and other fluororesins are preferred. In Embodiment 1, PFA was used as the material for the surface layer of the charging roller 22.

The charge removing sheet 23 is disposed so as to come into contact with the surface of the charging roller 22, which is the charging unit, so as to remove the charge from the surface. In addition, a conductive sheet is used as the material of the charge removing sheet, and the sheet is electrically grounded through the GND of the main body frame or the like to which no bias is applied. This allows the charge charged on the surface layer of the charging roller 22 to escape to the GND by the rubbing of the brush 21a and the surface layer of the charging roller 22. As a result, when the rotating charging roller 22 rubs against brush 21a again, the charge quantity on the brush 21a increases. This makes it possible to increase the charge quantity on the brush 21a compared to a case in which there is no charge removing sheet 23. The charge removing unit for removing the charge from the surface of the charging roller 22 is not limited to the charge removing sheet 23 and may be a conductive brush or charge removing needle that abuts against the surface of the charging roller 22 and is electrically grounded.

The blade 24 is made of an elastic polyurethane resin and is a scraping unit that abuts against the brush 21a and scrapes off the toner T that has been collected by and adhered to the brush 21a from the brush 21a to collect the toner. The toner T scraped off by the blade 24 is stored in the waste toner container 25, which is a container for storing waste toner.

With the cleaning device 20 configured as above, the surface layer portion (brush 21a) made of an insulating material and provided on the surface of the brush roller 21 is positively charged by the charging roller 22, and the toner on the surface of the intermediate transfer belt 10 is electrostatically collected. A negative charge is induced on the charging roller 22, and this negative charge on the charging roller 22 is removed by the charge removing sheet 23, so that the brush roller 21 is stably charged positively by the friction between the charging roller 22 and the brush roller 21. Therefore, the amount of toner collected by the brush roller 21 can be prevented from decreasing, and the collection performance of the toner, which is the objects to be collected, on the surface of the intermediate transfer belt 10, which is the object to be cleaned, can be improved.

### Verification of Effects

Next, the cleaning performance of the intermediate transfer belt was evaluated for Embodiment 1 and comparative example. In the comparative example, the basic configuration was the same as that of Embodiment 1, but the charge removing sheet 23 was not included.

A total of 1000 images of two superimposed colors (toner laid-on level: 1.0 mg/cm²) with 100% image data of yellow and magenta were consecutively printed on A4 size GF-C081 paper (manufactured by Canon Inc.). Then, the state of the toner T after passing through the cleaning device 20 on the intermediate transfer belt 10 was checked. Consecutive printing of 1000 images of two superimposed colors is a tough condition for the cleaning device 20 because of a large amount of intermediate transfer residual toner.

In the above evaluation, in the configuration of Embodiment 1, no streaky toner loss occurred, and the cleaning performance was good. Meanwhile, in the comparative example, streaky cleaning failures of toner T occurred after several hundred prints.

As regards this difference, it is thought that due to the presence of the charge removing sheet 23 in Embodiment 1, the charge generated by the friction of the surface layer of the charging roller 22 and charged on the surface layer of the charging roller 22 escaped to GND, and the charge quantity on the brush 21a was increased, which contributed to the cleaning performance.

Although a roller-shaped configuration is shown as an example of the charging member in Embodiment 1, a brush-shaped or sheet-shaped charging member may also be used.

### Embodiment 2

The characteristic feature of Embodiment 2 is that a part of the brush, which is the collecting unit, is made of a conductive member and is grounded through the GND of the main body frame or the like to which no bias is applied. Below, elements having substantially the same configuration and function as those in Embodiment 1 will be given the same reference numerals as those in Embodiment 1 and the explanation thereof will be omitted.

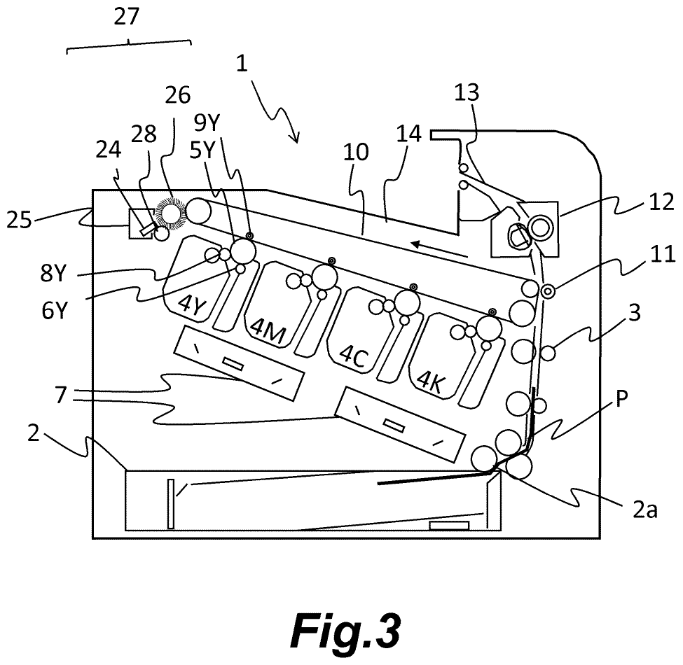

FIG. 3 is a cross-sectional view showing the overall configuration of Embodiment 2 in which the configuration of a cleaning device 27 is different from that of Embodiment 1.

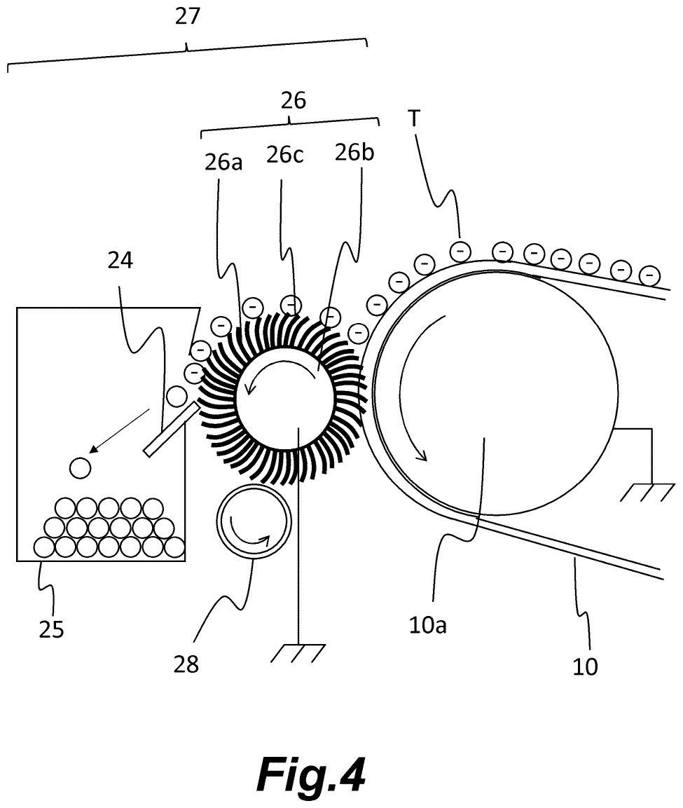

FIG. 4 shows the configuration of the cleaning device 27, which is a characteristic feature of Embodiment 2, and how the toner T adhered to the intermediate transfer belt 10 is collected. In Embodiment 2, a brush roller 26 has a rotating body similarly to the configuration of Embodiment 1, but the rotating body has a core metal 26b which is a conductive member, and the core metal 26b is electrically grounded through the GND of the main body frame or the like to which no bias is applied. The brush of the brush roller 26 has insulating piles 26a which are insulating bristles fixed to the rotating body, and conductive piles 26c which are conductive bristles made of a conductive material fixed to the rotating body and electrically connected to the core metal 26b. Therefore, the conductive piles 26c are grounded through the conductive core metal 26b through the GND of the main body frame or the like to which no bias is applied. Further, Nylon is used as the material for the insulating piles 26a. In addition, PFA is used as the material for the surface layer of a charging roller 28. As a result, in Embodiment 2, the charge removing unit that comes into contact with the surface of the charging roller 28 to remove charges present on the surface includes the core metal 26b and conductive piles 26c of the brush roller 26.

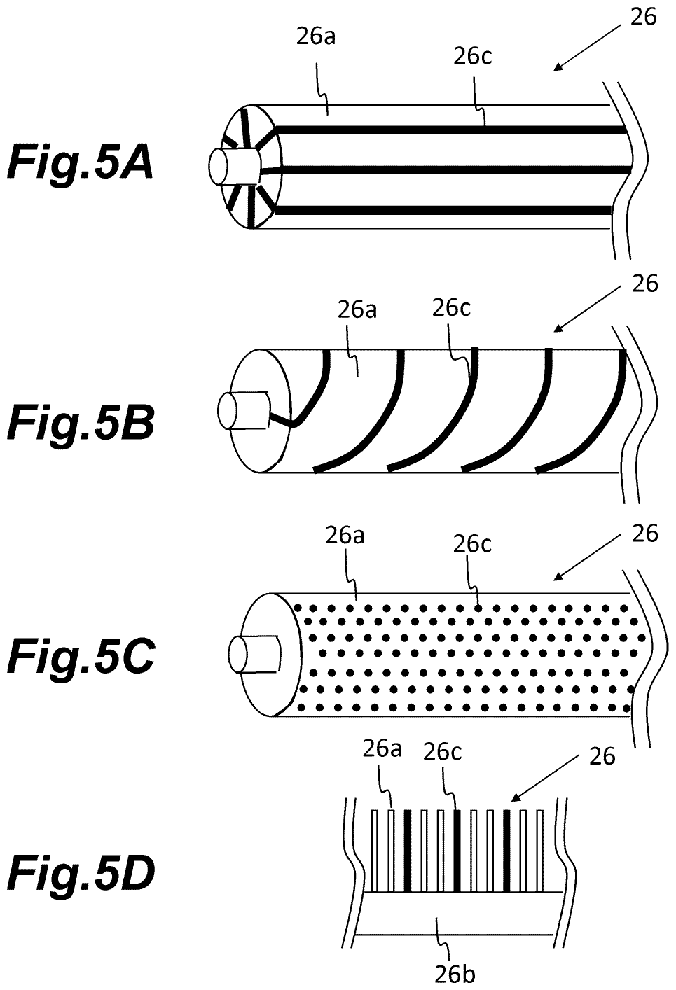

FIGS. 5A to 5B are structural diagrams of the brush roller 26 in Embodiment 2 showing three forms of the arrangement of the conductive piles 26c. In FIG. 5A, the conductive piles 26c are arranged to extend in the longitudinal direction of the brush roller 26, and a plurality of conductive piles 26c (eight in the example shown in FIG. 5A) is arranged at intervals along the rotation direction. In FIG. 5B, the conductive piles 26c are arranged in a spiral shape on the brush roller 26. In FIG. 5C, the conductive piles 26c are arranged so as to be scattered. Also, as shown in FIG. 5D, the conductive piles 26c are configured to ensure electrical continuity with the conductive core metal 26b.

The proportion of the conductive piles 26c is preferably not less than 1% and not more than 30%, more preferably not less than 2% and not more than 10%, of the total number of piles including the insulating piles 26a. Where the proportion of the conductive piles 26c is small, the ability to remove charge from the charging roller 28, which also serves as a charging unit, decreases, so the charge quantity on the brush roller 26 decreases, and as a result, the collection performance of the remaining toner T decreases. Meanwhile, where the proportion of the conductive piles 26c is large, the charge charged to the brush roller 26 escapes through the conductive piles 26c, and in this case, the collection performance of the remaining toner T also decreases. As a result of the study, it was found that the remaining toner T can be collected suitably by setting the proportion of the conductive piles 26c as in the above example.

The same effect can be achieved by using a conductive sheet instead of the conductive piles 26c in Embodiment 2.

### Embodiment 3

In Embodiment 3, paper dust generated from the sheet P is collected by an electrostatic collecting device in an image forming device 30.

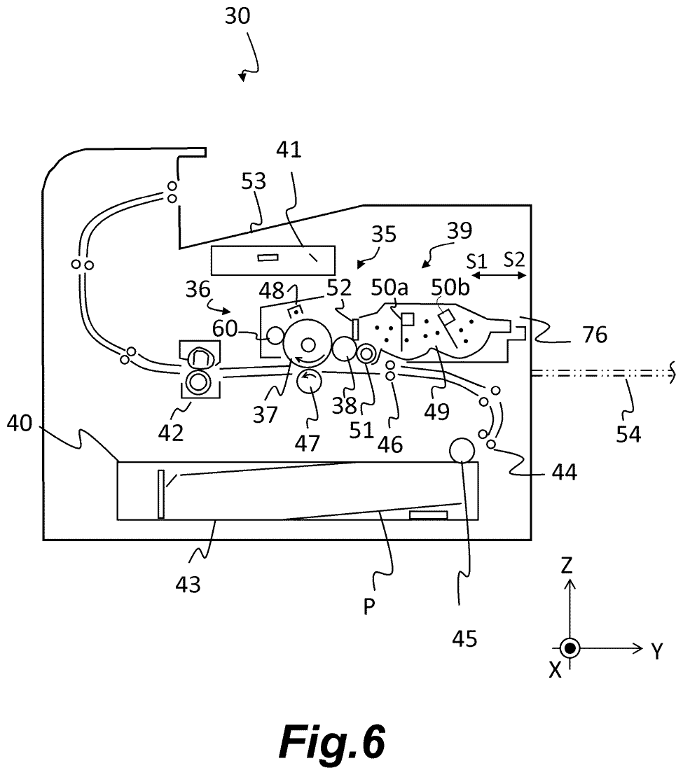

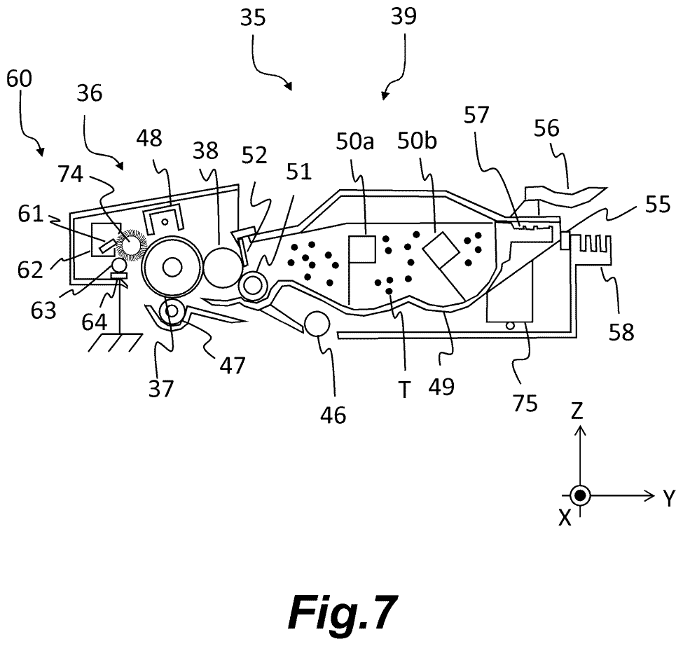

The configuration of the image forming device of Embodiment 3 will be described with reference to FIGS. 6 and 7. FIG. 6 is a cross-sectional view showing the configuration of the electrophotographic image forming device 30. In the following description, the left-right direction in the image forming device 30 (direction perpendicular to the paper surface in FIG. 6) is the X direction, the depth direction (left-right direction in FIG. 6) is the Y direction, and the up-down direction (up-down direction in FIG. 6) is the Z direction. The direction toward the left side when the image forming device 30 is viewed from the front side (right side of FIG. 6) of the image forming device 30 is the +X direction, the direction toward the front side from the rear side (left side of FIG. 6) of the image forming device 30 is the +Y direction, and the vertical upward direction when the image forming device 30 is installed on a horizontal surface is the +Z direction. The X direction is also referred to as the left-right direction of the image forming device 30, the Y direction is referred to as the front-rear direction in the image forming device 30, and the Z direction is referred to as the up-down direction in the image forming device 30. The X direction, Y direction, and Z direction are perpendicular to each other, the X direction and Y direction are parallel to the horizontal direction, and the Z direction is parallel to the vertical direction. A process cartridge 35 will be described using the above directions defined for the image forming device 30, with the orientation of the process cartridge when it is installed in the image forming device 30 as the reference.

The rotation axis direction of a photosensitive drum 37, which is an image bearing member and a photosensitive member, and the rotation axis direction of a developing roller 38, which is a developer carrying member, are parallel to the X direction. A developing unit 39 is mounted on a photosensitive unit 36 and integrated therewith into one unit which is called the process cartridge 35. The insertion direction (installation direction) S1 and removal direction S2 when installing the process cartridge 35 in the image forming device 30 are parallel to the Y direction.

### Image Forming Device

FIG. 6 is a cross-sectional view of the image forming device 30 with the process cartridge 35 installed. The cross section in FIG. 6 is perpendicular to the X direction. As shown in FIG. 6, the image forming device 30 has a feeding unit 40 for supplying sheets P such as paper into the image forming device 30. Furthermore, the image forming device 30 has an exposure device 41 as an exposing unit, and the process cartridge 35 that transfers a toner image as a developer image onto the sheet P. Furthermore, the image forming device 30 has a fixing device 42 as a fixing unit for thermally fixing the toner image transferred onto the sheet P.

### Feeding Unit

The feeding unit 40 is provided in the lower part of the image forming device 30 and includes a feeding tray 43, a feeding roller 45, and a separation roller 44. The sheets P stored in the feeding tray 43 are fed by the feeding roller 45 and separated one by one by the separation roller 44. The sheets are then conveyed by a conveying roller. The leading edge of the sheet P conveyed by the conveying roller is abutted against the nip of stopped registration rollers 46, and skew is corrected. The sheet is then conveyed toward a transfer nip formed by the photosensitive drum 37 provided in the process cartridge 35 and a transfer roller 47 as a transfer unit.

### Image Forming Operation

Next, the image forming operation by the process cartridge 35 will be described with reference to FIG. 6. The photosensitive drum 37 is rotated clockwise in FIG. 6 during the image forming process. First, the surface of the photosensitive drum 37 is uniformly charged by a charging device 48, and then exposed by a laser beam that is emitted from the exposure device 41 and corresponds to the image data, thereby forming an electrostatic latent image corresponding to the image data on the surface of the photosensitive drum 37.

The developing unit 39 has a toner storage section 49 where toner is stored, stirring members 50a and 50b that stir and convey the toner in the toner storage section 49, and a supply roller 51 that supplies the toner located in the toner storage section 49 to the developing roller 38. The layer thickness of the toner supplied to the developing roller 38 is regulated by a regulating blade 52. The toner T carried on the surface of the developing roller 38 is supplied to the electrostatic latent image formed on the surface of the photosensitive drum 37. As a result, the toner T adheres to the electrostatic latent image formed on the surface of the photosensitive drum 37, making it visible, and develops the latent image as a toner image on the surface of the photosensitive drum 37. After that, the sheet P is conveyed to the transfer nip formed between the photosensitive drum 37 and the transfer roller 47, and the toner image on the surface of the photosensitive drum 37 is transferred onto the sheet P.

The fixing device 42 is disposed behind the process cartridge 35, and when the sheet P with the transferred toner image passes through the fixing device 42, the sheet P carrying the toner image is heated and pressurized to fix the toner image onto the sheet P. The sheet P that has passed through the fixing device 42 is conveyed by the conveying roller, and then discharged onto a discharge tray 53 by a discharge roller.

### Collection of Untransferred Toner

The toner T that is not transferred to the sheet P during transfer and remains on the surface of the photosensitive drum 37 is collected into the toner storage section 49 of the developing unit 39 and reused. Specifically, the surface of the photosensitive drum 37 is charged once by the charging device 48, and the surface potential of the photosensitive drum 37 is made higher than the potential of the developing roller 38. As a result, the residual toner positively charged on the surface of the photosensitive drum 37 moves to the developing roller 38 and is collected from the surface of the developing roller 38 into the toner storage section 49.

### Process Cartridge

Next, the configuration of the process cartridge 35 will be described with reference to FIGS. 6 and 7. FIG. 7 is a cross-sectional view showing the configuration of the process cartridge 35 of Embodiment 3. The process cartridge 35 shown in FIG. 7 includes the photosensitive unit 36 and the developing unit 39 that is detachable from the photosensitive unit 36.

As shown in FIG. 6, the process cartridge 35 is disposed below the exposure device 41. The process cartridge 35 is inserted in the main body of the image forming device 30 in an insertion direction S1 through an opening 76 that is created when a door 54, which is an opening/closing member provided on the image forming device 30, is opened to the state shown by the two-dot chain line in FIG. 6. The inserted process cartridge is mounted on the device main body. When removing the process cartridge 35 from the device main body, the door 54, which is as an opening/closing member provided on the device main body, is opened to the state shown by the two-dot chain line in FIG. 6, and the process cartridge 35 is moved in a removal direction S2 and taken out from an opening 76.

The photosensitive unit 36 is provided with a gripping portion 58 that allows the user to grip the photosensitive unit 36. The photosensitive unit 36 is also provided with a mounting portion 75 on which the developing unit 39 can be mounted, a pressing member 55 that presses the developing unit 39, and a lifting member 56 that lifts the developing unit 39.

The pressing member 55 presses the developing unit 39 mounted on the photosensitive unit 36, thereby urging the developing roller 38 toward the photosensitive drum 37. The lifting member 56 can be operated by the user to remove the developing unit 39 from the photosensitive unit 36 for replacement, and a gripping portion 57 is provided in front of the developing unit 39 for the user to grip.

### Paper Dust Removal Device

As shown in FIG. 7, a paper dust removal device 60 includes a brush roller 74 as a collecting unit, a charging roller 63 as a charging unit, a charge removing sheet 64 as a charge removing unit, a blade 61, and a paper dust collecting container 62.

The brush roller 74 faces the surface of the photosensitive drum 37 on a downstream side of the transfer nip portion (transfer roller 47) in the rotation direction of the photosensitive drum 37 (clockwise in FIG. 7). The brush roller 74 collects the adhered paper dust that has been released from the sheet P while allowing the toner T remaining on the surface of the photosensitive drum 37 to pass through. The blade 61 is made of elastic polyurethane resin and scrapes off the paper dust that has adhered to the brush roller 74, and the paper dust is collected in the paper dust collecting container 62.

Most paper dust is positively charged. Therefore, in order to allow the negatively charged toner T to pass through, in Embodiment 3, PFA is used as a material for the brush roller 74 and Nylon is used as the material for the surface layer of the charging roller 63, so that the brush roller 74 is negatively charged.

Furthermore, as in Embodiment 1, the charge removing sheet 64 is arranged so as to contact the surface layer of the charging roller 63. In addition, a conductive sheet is used as the material of the charge removing sheet and is grounded through the GND of the main body frame or the like to which no bias is applied. This increases the charge quantity on the brush roller 74, which in turn makes it possible to increase the amount of paper dust collected.

### Embodiment 4

The characteristic feature of Embodiment 4 is in paper dust collection at a registration roller section. Thus, the paper dust from the sheet P is actively collected at the registration roller section, thereby reducing the amount of paper dust adhering to the photosensitive drum. Below, elements having substantially the same configuration and function as those in Embodiment 3 will be given the same reference numerals as those in Embodiment 3 and the explanation thereof will be omitted.

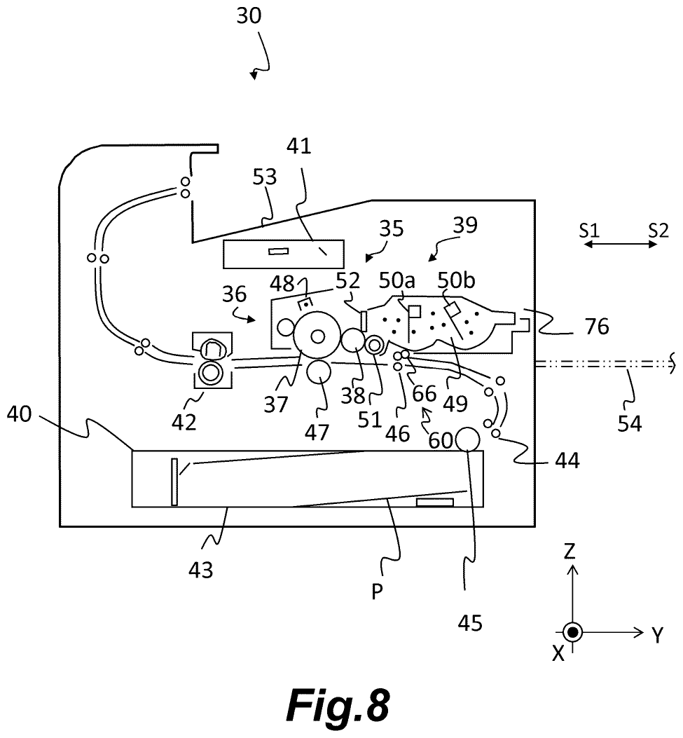

FIG. 8 is a cross-sectional view showing the overall configuration of Embodiment 4, in which a charging roller 66, which is part of the paper dust removal device 60, is arranged to abut against the registration roller 46.

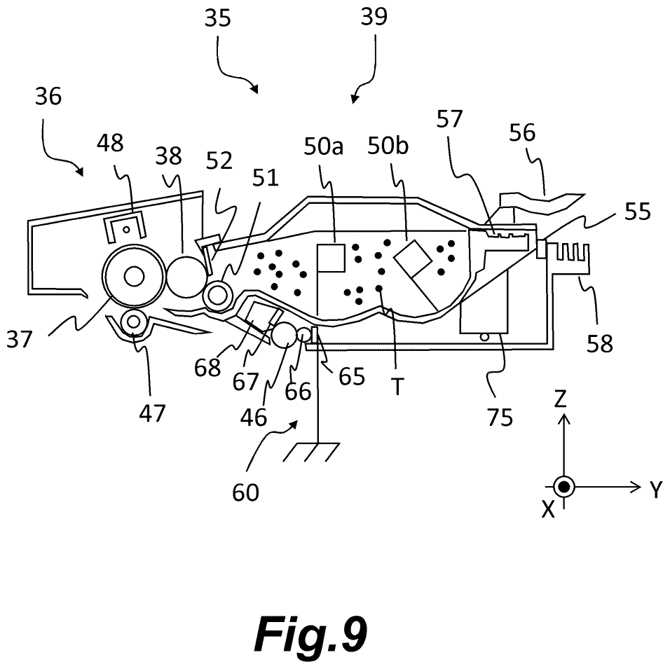

FIG. 9 is a cross-sectional view showing the configuration of the process cartridge 35 of Embodiment 4. The charging roller 66 is arranged to abut against the registration roller 46, and a charge removing sheet 65 is arranged to abut against the charging roller 66. In addition, a blade 67 is arranged to abut against the registration roller 46. In order to actively collect paper dust with the registration roller 46, it is preferable to charge the registration roller 46 to a negative polarity as described in Embodiment 3. In Embodiment 4, PFA is used as the material of the registration roller 46, and Nylon is used as the material of the surface layer of the charging roller 66. As in Embodiment 3, in order to increase the charge quantity on the registration roller 46, the charge removing sheet 65 is arranged so as to contact the surface layer of the charging roller 66. A conductive sheet is used as the material of the charge removing sheet, and the sheet is grounded through the GND of the main body frame or the like to which no bias is applied.

By negatively charging the registration roller 46, paper dust that is easily released from the sheet P is electrostatically attached to the registration roller 46. The paper dust on the registration roller 46 is scraped off by the blade 67 and collected in a paper dust collecting container 68. As a result, the transfer of paper dust that is easily released from the sheet P to the photosensitive drum 37 can be suppressed. In Embodiment 4, the registration roller 46 is a collecting unit for collecting paper dust, which is the objects to be collected, from the sheet P, which is the recording medium to be cleaned.

### Embodiment 5

The characteristic feature of Embodiment 5 is in paper dust collection at the transfer roller section. Below, elements having substantially the same configuration and function as those in Embodiment 3 will be assigned the same reference numerals as in Embodiment 3 and the explanation thereof will be omitted.

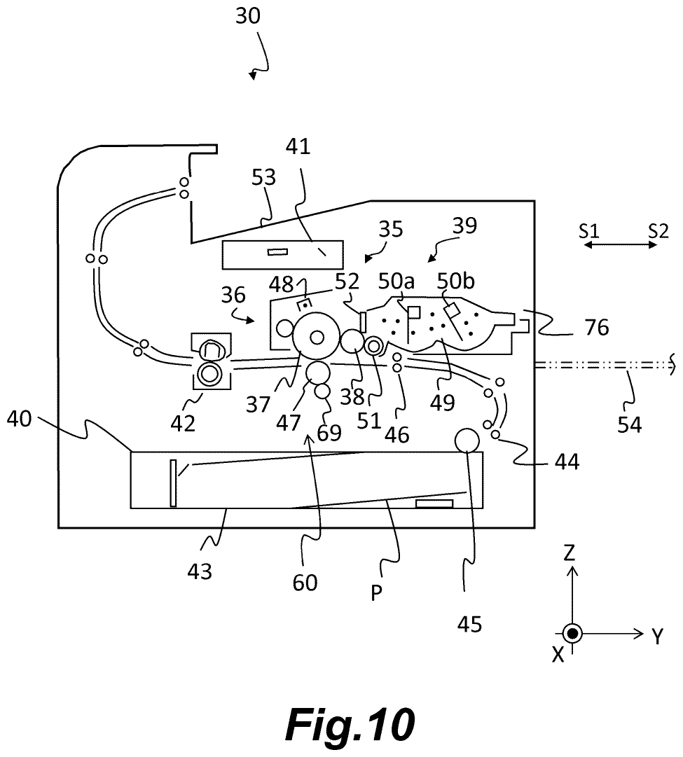

FIG. 10 is a cross-sectional view showing the overall configuration of Embodiment 5, in which a brush roller 69, which is part of the paper dust removal device 60, is arranged to abut against the transfer roller 47.

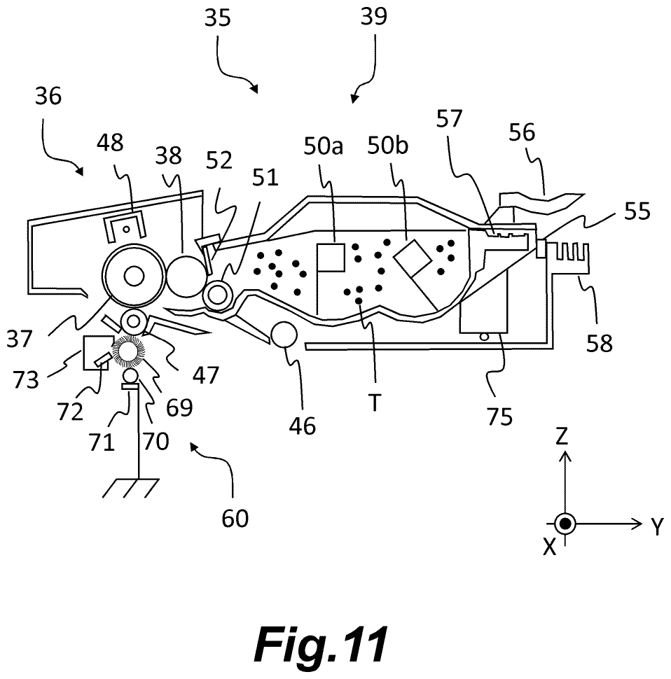

FIG. 11 is a cross-sectional view showing the configuration of the process cartridge 35 of Embodiment 5. The recording medium is sandwiched between the rotatable transfer roller 47 and the rotatable photosensitive drum 37, and the toner image is transferred from the photosensitive drum 37. The brush roller 69 is arranged to abut against the transfer roller 47, and a charging roller 70 is arranged to abut against the brush roller 69. In addition, a charge removing sheet 71 is arranged to abut against the charging roller 70. As in Embodiment 3, a conductive sheet is used as the material of the charge removing sheet 71, and the sheet is grounded through the GND of the main body frame or the like to which no bias is applied. A blade 72 is disposed so as to abut against the brush roller 69.

To actively collect paper dust with the brush roller 69, as described in Embodiment 3, it is preferable to charge the brush roller 69 to a negative polarity. In Embodiment 5, PFA is used as the material of the brush roller 69, and Nylon is used as the material of the surface layer of the charging roller 70.

Paper dust adhering to the transfer roller 47 is collected by the brush roller 69 and is then scraped off by the blade 72 and collected in a paper dust collecting container 73. As a result, the transfer of paper dust adhering to the transfer roller 47 to the photosensitive drum 37 can be suppressed.

### Embodiment 6

Embodiment 6 has a different application from the Embodiments 1 to 5. Embodiment 6 is a cleaning device that cleans dust on the floor. The object to be cleaned is a floor, and the objects to be collected on the object to be cleaned is dust present on the floor.

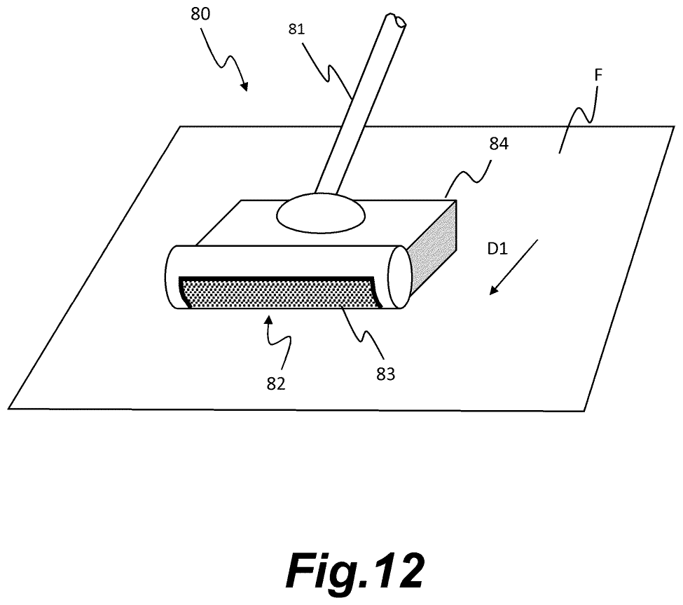

FIG. 12 is a diagram showing the external appearance of the cleaning device of Embodiment 6. A cleaning device 80 is a manual vacuum cleaner that allows a user to hold a handle 81 and clean the surface F to be cleaned while pushing the cleaning device in the direction of an arrow D1. The front of the cleaning device 80 has an opening 82 for taking in dust, a brush roller 83 that rotates to scrape off dust from the surface F to be cleaned, and a storage section 84 that stores the scraped-off dust H.

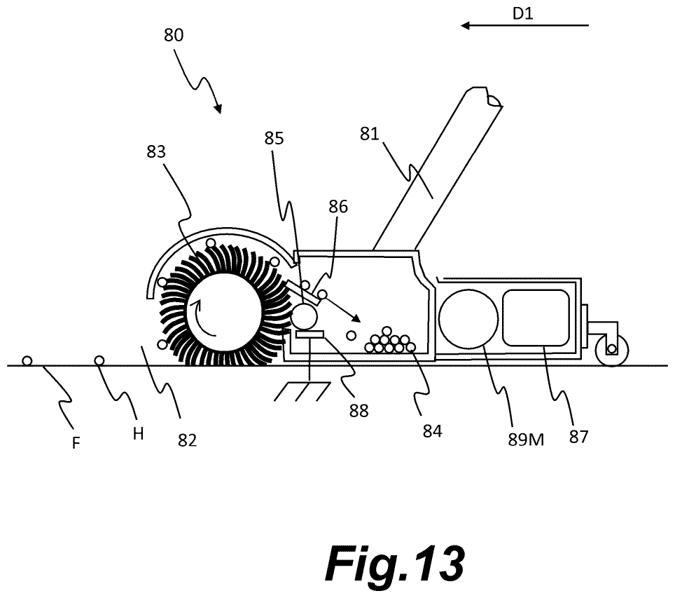

FIG. 13 is a cross-sectional view showing the internal configuration of the cleaning device 80 and how dust H on the floor F is collected. The cleaning device includes the brush roller 83, a blade 86, a storage section 84, a charging roller 85, and a charge removing sheet 88. The brush roller 83 comes into contact with the floor F, which is the object to be cleaned, and collects dust H adhered to the floor F. The dust H is scraped off by the blade 86 and is finally stored in the storage section 84. The brush roller 83 is rotated in the direction of the arrow by a motor 89M as a driving unit and a drive transmission unit (not shown). A battery 87 supplies power to the motor 89M.

The charging roller 85 is arranged to abut against the brush roller 83. The charge removing sheet 88 is arranged to contact the surface of the charging roller 85. In addition, a conductive sheet is used as the material of the charge removing sheet and grounded through the GND of the main body frame or the like to which no bias is applied.

Most dust H that exists in nature is positively charged. Therefore, it is preferable that the brush roller 83 be negatively charged, and in Embodiment 6, PFA is used as the material for the brush roller 83, and Nylon is used as the material for the surface layer of the charging roller 85.

The present disclosure is not limited to the above-mentioned applications and can be used in various fields. For example, the present disclosure can be applied to removing dust from the surfaces of glass substrates for displays and semiconductor wafers and also to removing dust from the surface of an electrostatic attraction stage that holds these substrates in a vacuum chamber, and the effects of the present disclosure can be similarly obtained in these applications.

According to the present disclosure, it is possible to provide an electrostatic collecting device that increases the charge quantity of the collecting unit with a simple configuration and improves the collection performance of the objects to be collected from the surface of the object to be cleaned.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-186869, which was filed on Oct. 31, 2023 and which is hereby incorporated by reference herein in its entirety.

What is claimed is:

1. An electrostatic collecting device comprising:
a collecting unit facing a surface of an object to be cleaned, electrostatically collecting objects to be collected existing on the surface of the object to be cleaned, and having a rotating body and a brush provided on a surface of the rotating body;
a charging unit having an insulating member rubbing against the collecting unit and charging the collecting unit by the insulating member; and
a charge removing unit contacting a surface of the charging unit, electrically grounded to remove charge from the surface of the charging unit, and having a conductive brush, charge removing needle, or conductive sheet contacting the charging unit.

2. The electrostatic collecting device according to claim 1, wherein the brush has insulating bristles made of an insulating material and is configured to rub against at least the charging unit.

3. The electrostatic collecting device according to claim 1, wherein the charging unit has a rotating body.

4. The electrostatic collecting device according to claim 1 further comprising:
a scraping unit contacting the collecting unit, scraping off the collected objects to be collected from the collecting unit, and being an elastic blade; and
a container storing the objects to be collected scraped off by the scraping unit.

5. An electrostatic collecting device comprising:
a collecting unit facing a surface of an object to be cleaned, electrostatically collecting objects to be collected existing on the surface of the object to be cleaned, and having a rotating body and a brush provided on a surface of the rotating body, the rotating body having an electrically grounded conductive member;
a charging unit having an insulating member rubbing against the collecting unit and charging the collecting unit by the insulating member; and
a charge removing unit including the conductive member of the rotating body and conductive bristles made of conductive material provided at the brush of the collecting unit and electrically connected to the conductive member, the charge removing unit being configured to remove charge from a surface of the charging unit by contacting the surface of the charging unit.

6. The electrostatic collecting device according to claim 5, wherein the brush has insulating bristles made of an insulating material and is configured to rub against at least the charging unit.

7. The electrostatic collecting device according to claim 5, wherein the proportion of the conductive bristles among the bristles provided on the brush is not less than 1% and not more than 30%.

8. The electrostatic collecting device according to claim 5, wherein the charging unit has a rotating body.

9. The electrostatic collecting device according to claim 5 further comprising:
a scraping unit contacting the collecting unit, scraping off the collected objects to be collected from the collecting unit, and being an elastic blade; and
a container storing the objects to be collected scraped off by the scraping unit.

10. An image forming device comprising:
a photosensitive drum on which an electrostatic latent image is formed;
a developing unit configured to develop the electrostatic latent image into a toner image;
a transfer unit configured to transfer the toner image to a recording medium or an intermediate transfer member; and
the electrostatic collecting device according to claim 1 collecting paper dust as the objects to be collected generated from the recording medium from the surface of the photosensitive drum as the object to be cleaned.

11. The image forming device according to claim 10,
wherein the photosensitive drum has a rotating body, and
wherein the collecting unit faces the surface of the photosensitive drum on a downstream side of the transfer unit in the rotation direction of the photosensitive drum and is configured to collect paper dust from the surface of the photosensitive drum.

12. An image forming device comprising:
a photosensitive drum on which an electrostatic latent image is formed;
a developing unit configured to develop the electrostatic latent image into a toner image;
a transfer unit configured to transfer the toner image to an intermediate transfer member; and
the electrostatic collecting device according to claim 1 collecting toner as the objects to be collected from the intermediate transfer member as the object to be cleaned.

13. The image forming device according to claim 12, wherein the charging unit is configured to charge the collecting unit to a polarity opposite to the regular charging polarity of the toner.

14. An image forming device comprising:
a rotatable photosensitive drum on which an electrostatic latent image is formed;
a developing unit configured to develop the electrostatic latent image into a toner image;
a transfer unit configured to transfer the toner image to a recording medium or an intermediate transfer member;
a conveying roller configured to convey the recording medium; and
the electrostatic collecting device according to claim 1 collecting paper dust, as the objects to be collected generated from the recording medium, from the recording medium as the object to be cleaned,
wherein the collecting unit of the electrostatic collecting device has the conveying roller.

15. An image forming device comprising:
a rotatable photosensitive drum on which an electrostatic latent image is formed;
a developing unit configured to develop the electrostatic latent image into a toner image;
a rotatable transfer roller configured to transfer the toner image to a recording medium held between the photosensitive drum and the transfer roller; and
the electrostatic collecting device according to claim 1 collecting paper dust, as the objects to be collected generated from the recording medium, from the transfer roller as the object to be cleaned.

16. A cleaning device comprising:
a collecting unit facing a surface of an object to be cleaned, electrostatically collecting dust as objects to be collected existing on the surface of the object to be cleaned, and having a rotating body and a brush provided on a surface of the rotating body;
a charging unit having an insulating member rubbing against the collecting unit and charging the collecting unit by the insulating member; and
a charge removing unit contacting a surface of the charging unit, electrically grounded to remove charge from the surface of the charging unit, and having a conductive brush, charge removing needle, or conductive sheet contacting the charging unit.

17. The cleaning device according to claim 18 further comprising a driving unit configured to drive the collecting unit.
